(19) United States
(12) Patent Application Publication
(10) Pub. No.: US 2025/0218636 A1
(43) Pub. Date: Jul. 3, 2025

(54) SPHERICAL MAGNETIC FLUX CONCENTRATOR

(71) Applicant: Daniel Jones, Pinellas Park, FL (US)

(72) Inventor: Daniel Jones, Pinellas Park, FL (US)

(21) Appl. No.: 18/398,400

(22) Filed: Dec. 28, 2023

(51) Int. Cl. H01F 7/20; H01F 7/02

(52) U.S. Cl. CPC H01F 7/202; H01F 7/0273

(57) ABSTRACT

The invention relates to a unique configuration of magnets or electromagnets arranged on the inside surface of a spherical housing. Using two hemispherical housings with attached electromagnets wound with tapered cylindrical windings mounted together to form a full spherically configured magnetic flux concentrator is presented with calculated flux lines. Tapered cylindrical wound electromagnets fulfill two needs, one is to help with the flux concentration and the other is to fit the coil on the inside of the spherical housing, maximizing mounting space and use of available volume. A coil gun is presented as a practical application using three concentrators ganged together.

### PRIOR ART

### U.S. Patent Documents

U.S. Pat. No. 9,245,677B2 2016 Jan. 26 Larry W. Fullerton H01F7/0252

U.S. Pat. No. 8,791,351B2 2014 Jul. 29 Christopher Kinman G10H3/181

U.S. Pat. No. 10,041,757B2 2018 Aug. 7 James A. Grossnickle F41B6/003

### Foreign Patent Documents

WO1996017257A1 1996 Jun. 6 Gregory Aharonian G01R33/00

JP2022547945A 2023 Sep. 14 G01R33/0011

### BACKGROUND OF THE INVENTION

Magnetic flux concentrators are used in a variety of ways including fusion generators and rail guns. A unique configuration of electromagnets arranged in a spherical configuration allow the magnetic flux to be concentrated to a small region, at the center of the spherical housing, amplifying the flux for better application needing high generated flux levels.

### SUMMARY OF THE INVENTION

The invention is a unique configuration of magnets or electromagnets arranged on the inside surface of a spherical housing.

This disclosure provides two hemispherical housings with attached electromagnets wound with tapered cylindrical windings mounted together to form a full spherically configured magnetic flux concentrators. Tapered cylindrical wound electromagnets fulfill two needs, one is to help with the flux concentration and the other is to fit the coil on the inside of the spherical housing, maximizing mounting space and use of available volume. The electromagnets may be fired manually, or with proximity sensors, as needed. Coils may be connected in parallel to maximize current flow or series for control purposes.

The spherical sub-assemblies may be ganged together, for example, for use in a coil gun, of for subsequent exposure to high flux density regions.

### BRIEF DESCRIPTION OF DRAWINGS

For a more complete understanding of this disclosure and features, reference is made to the following description, along with the related drawings, in which:

FIG. 1 illustrates the electromagnets arranged on the inside of a hemisphere.

FIG. 2 illustrates the calculated flux for the spherical concentrators in an axis-symmetric view.

FIG. 3 illustrates how, as an example, a magnetic conductor reacts to generated flux. concentrated at the center of the sphere. Reference FIG. 2.

FIG. 4 illustrates how, as a practical application, an example coil gun configuration.

FIG. 5 illustrates a cross-section of FIG. 4.

### DETAILED DESCRIPTION OF THE INVENTION

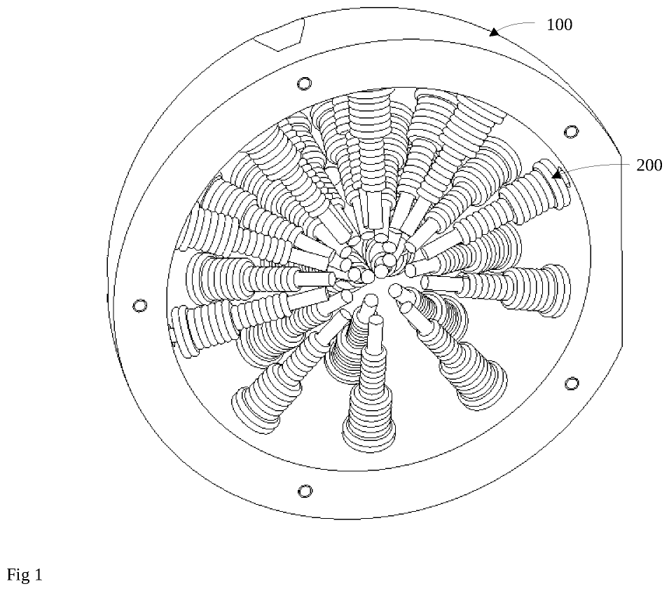

FIGS. 1 through 5, described below, and the various representations used to describe the principles of the present invention in this document are by way of illustration only and should not be construed in any way to limit the scope of the invention. Those skilled in the art will understand that the principles of the present invention may be implemented in any type of suitable arranged device or system. The presented configuration is easily scalabe.

The invention relates to electromagnets configured to increase the magnetic flux density at the center of the spherical housing. Each of the electromagnets are arranged to point at the direct center of the sphere. The electromagnets with tapered cylindrical windings are mounted to the inside of the sphere. Optimal flux density is achieved with proper housing size, electromagnet core size, wire diameter and current input. The electromagnets must be securely mounted to the inside of the housing and sized to transmit the generated load, and resultant stress to the inside housing surface as the like poles are adjacent to each other, and large repulsive forces are created during the firing of the electromagnets.

This disclosure provides a configuration for a typical arrangement of electromagnets, but other arrangements are possible as well as the use of arc-shaped permanent magnets.

### Description of Preferred Embodiment

FIG. 1 illustrates an exemplary embodiment of a spherical magnetic flux concentrator according to the present invention in a three-dimensional isometric view. The spherical magnetic flux concentrator 100 consists of a hemispherical housings and electromagnets 200 mounted to the inside surface of the housing. One half of the spherical magnetic flux concentrator is shown.

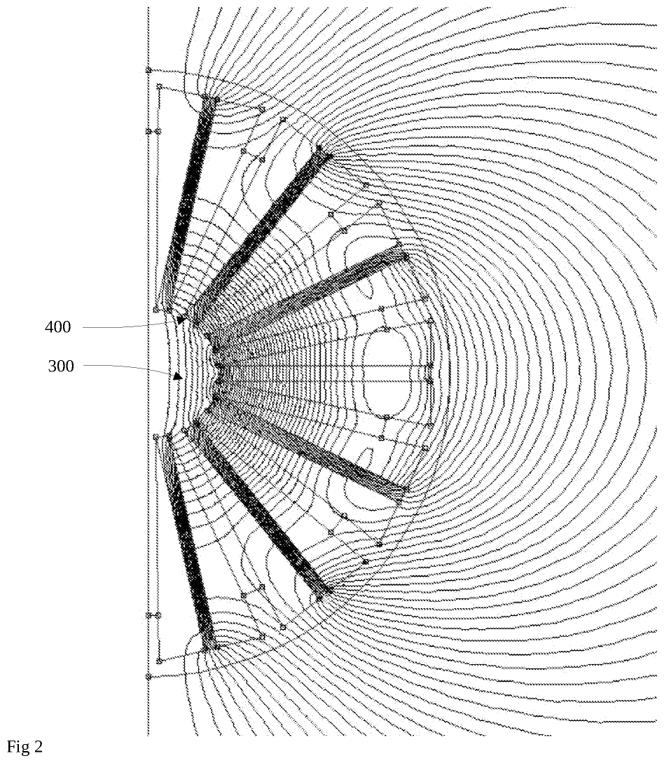

FIG. 2 illustrates how magnetic flux is concentrated 300 at the center of the housing when the electromagnet are energized to produce like poles 400 near the center of the sphere.

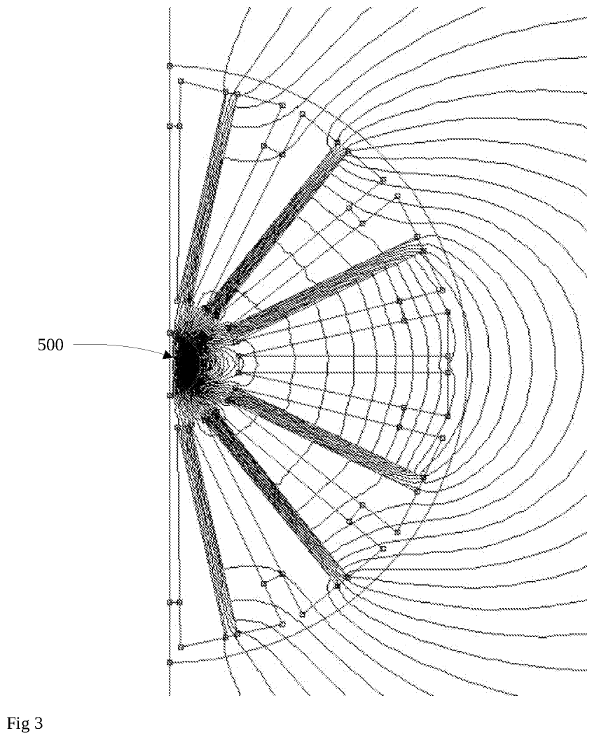

FIG. 3 illustrates how magnetic flux is concentrated at the center of the housing when the electromagnet are energized to produce like poles near the center of the sphere and a magnetic conductor 500 is place at the center of the sphere.

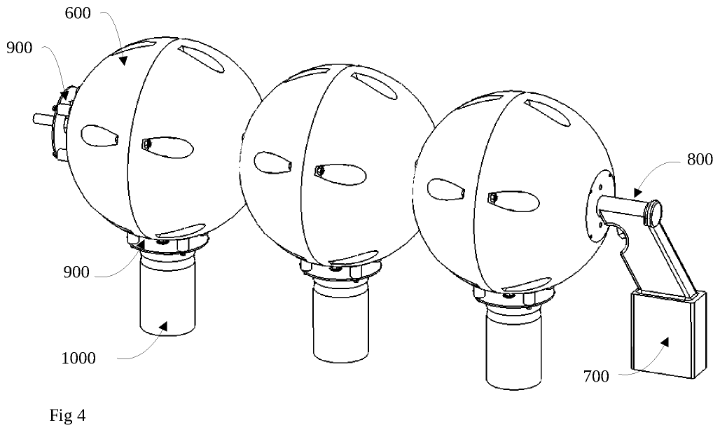

FIG. 4 illustrates a possible ganged configuration of spherical magnetic concentrators mounted in series. Control circuit 900, possible mounting and energy storage in the form of large capacitors 1000 are shown as well as a battery power source 700 and projectile injector 800.

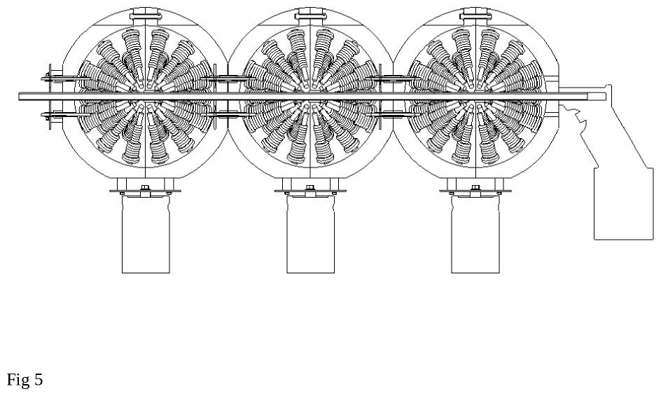

FIG. 5 illustrates a cross-section of FIG. 4 showing possible hall sensor 1100 location to enable accurate coil firing.

1. Unique configuration of magnets or electromagnets arranged on the inside surface of a spherical housing.

2. Allows the magnetic flux to be concentrated to a small region, at the center of the spherical housing, amplifying the flux for better application needing high generated flux levels.

3. Two hemispherical housings with attached electromagnets wound with tapered cylindrical windings mounted together to form a full spherically configured magnetic flux concentrators.
